(19) United States
(12) Patent Application Publication
(10) Pub. No.: US 2008/0185193 A1
(43) Pub. Date: Aug. 7, 2008

(54) TOUCH PAD STRUCTURE

(76) Inventor: JAO-CHING LIN, Taipei (TW)

Correspondence Address: G. LINK CO., LTD., 3550 BELL ROAD, MINOOKA, IL, 60447, US

(21) Appl. No.: 11/668,783

(22) Filed: Jan. 30, 2007

(51) Int. Cl. G06F 3/044

(52) U.S. Cl. 178/18.06

(57) ABSTRACT

A touch pad structure includes a first substrate, a joining layer, a guide light layer, a second substrate and an illuminant component. The joining layer is adhered to a side of the first substrate. The guide light layer is disposed next to the joining layer. The second substrate is disposed next to another side of the first substrate and provides electrical circuit and a conductor with sensing loci. The illuminant component is provided beside periphery of the guide light layer to connect with the electrical circuit. The electrical circuit receives change of coupling capacitance at the time of an object touching the touch pad so as to control “On” and “Off” of the illuminant component.

### BACKGROUND OF THE INVENTION

1. Field of the Invention

The present invention is related to a touch pad structure and particularly to a device capable of being employed by an user to move curser, input data or conduct other applications.

2. Brief Description of the Related Art

it is known that the touch pad can offer various input functions for an electronic device such as simulation of physical keys, rolling keys or recognizing system for complicated mode or movement. For instance, U.S. Pat. No. 5,880,441 discloses a touch pad with outstanding feature of mobility or recognition of movement.

A lot of applications are required images presenting at the bottom of the touch pad for creating effect of graphical user interface (GUI). For example, the touch pad can cover or stacked on a liquid crystal display or a cathode-ray tube display to produce effect of GUI or the touch pad is needed to show static information at the bottom thereof such as advertisement massage or icon guiding users' input. However, the preceding subjects are not dealt with the prior art.

Besides, the conventional capacitance type touch pads such as U.S. Pat. Nos. 5,457,289, 4,806,709, 4,733,222 still has unsolved shortcomings. U.S. Pat. No. 5,457,289 has to be equipped with a front protection hood and US patent No. needs uniform conductive surface.

### SUMMARY OF THE INVENTION

In order to solve the preceding problem, an object of the present invention is to provide a touch pad structure which is capable of creating change of electrical characteristics to control “On” and “Off” of an illuminant.

Another object of the present invention is to provide a touch pad structure, which employs technique with regard to “On” and “Off” of an illuminant, for prompting the user if the touch pad is in a state of being actuated or the range defined by the touch pad is sensitively input.

Accordingly, a touch pad structure according to the present invention includes a first substrate, a joining layer, a guide light layer, a second substrate and an illuminant component. The joining layer is adhered to a side of the first substrate. The guide light layer is disposed next to the joining layer. The second substrate is disposed next to another side of the first substrate and provides electrical circuit and a conductor with sensing loci. The illuminant component is provided beside periphery of the guide light layer to connect with the electrical circuit. The electrical circuit receives change of coupling capacitance at the time of an object touching the touch pad so as to control “On” and “Off” of the illuminant component.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a block diagram illustrating an application mode with a touch pad structure according to the present invention;

FIG. 2 is a side view of a preferred embodiment of a touch pad according to the present invention;

FIG. 3 is a perspective view in associated with a block diagram illustrating another application mode with a touch pad structure according to the present invention;

FIG. 4 is a perspective view in associated with a block diagram illustrating a further application mode with a touch pad structure according to the present invention;

FIGS. 5 to 7 are plan views illustrating arrangements of the first conductor in a touch pad according to the present invention; and

FIGS. 8 to 13 are side views of further embodiments of a touch pad structure according to the present invention.

### DETAILED DESCRIPTION OF THE INVENTION

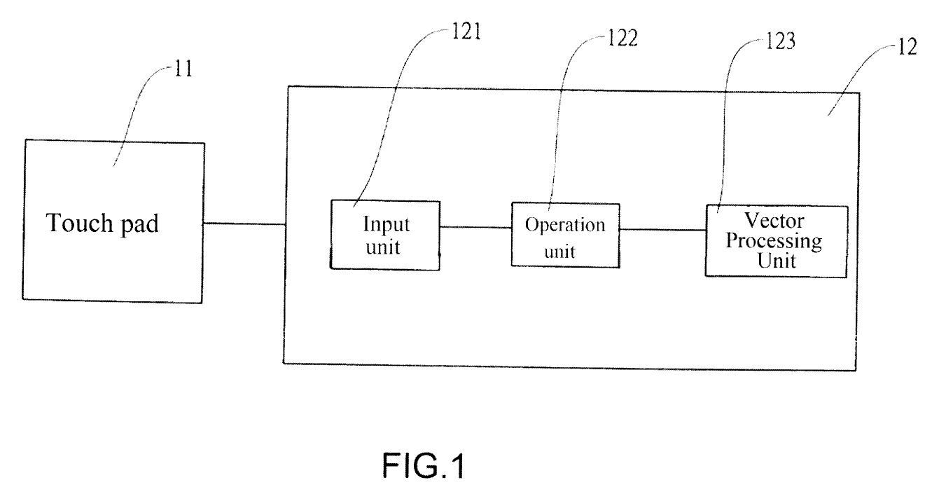

Referring to FIGS. 1, 3 and 4, a touch sensing system according to the present invention includes a touch pad 11, a sensing object O and a processor 12. The sensing object O can be such as a finger or a stylus, which is a conductive object for creating change of capacitance while closing to or touching the touch pad 11. That is, the sensing object O is capable of resulting in change of capacitance of at least a sensor locus or sensor trace provided in the touch pad 11. The processor 12 is connected to the touch pad 11 to determine if the sensing object O contacts the touch pad 11 and/or position of the sensing object O on the touch pad 11 by means of receiving or reading out the change of the capacitance.

The processor 12 further includes an input unit 121, an operation unit 122 and a vector processing unit 123 as shown in FIG. 1. The input unit 121 is capable of accessing data related to the preceding change of capacitance. The operation unit 122, which is connected to the input unit 121, is capable of digitalizing the data of the change of capacitance. The vector processing unit 123, which is connected to the operation unit 122 to receive the digitalized data, is capable of obtaining position information of the sensing object O once the object O touches the touch pad 11. The position information is utilized with a device or system such as a computer, a mobile phone, a personal digital assistant (PDA) and/or a screen of the preceding device, which is associated with the touch pad 11. For instance, as input/output (I/O) equipment of the device or system, the input unit 121, the operation unit 122 and the vector processing unit 123 are also capable of resisting noise induced with the touch pad 11.

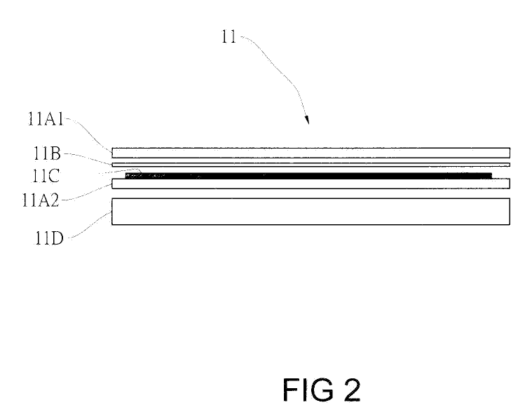

Referring to FIG. 2, a preferred embodiment of the touch pad structure according to the present invention is illustrated. The preceding sensing locus is capable of offering sufficient capacitance to couple the object O and can be a fine line composed of a conductor drawn at a preset position of the touch pad 11 available for contacting with the object O. It can be seen in FIG. 2 that the touch pad 11 provides a structure of the following stacked parts: a first substrate 11A1 and a second substrate 11A2. The first substrate 11A1 is light-penetrable at least at the top side thereof and is adhered to the second substrate 11A2, which is coated with a first light-penetrable conductor 11C and/or light-penetrable and insulated itself, with a light-penetrable and insulated adhesive 11B.

The preceding first conductor 11C is deposited onto the second substrate 11A2 by means of splashing or printing process normally. The first conductor 11C is formed with light-penetrable sensing loci and arrangement of the light-penetrable sensing loci is obtained by means of a light resistant agent and etching process. Alternatively, the light-penetrable sensing loci can be formed with splashing or optionally printing a negative figure layer over the second substrate 11A2. Once the negative figure layer is removed, the light-penetrable sensing loci are left on the second substrate 11A2.

The first substrate 11A1 and the second substrate 11A2 are made of polyester film, glass, polycarbonate plastics or Mylar, which is light-penetrable. Alternatively, the second base substrate 11A2 can be light-tight instead. The light-penetrable and insulated adhesive 11B can be such as 3M #8142, 467 or any other suitable adhesive. The light-penetrable conductor 11C can be made of material such as indium tin oxide (ITO), transparent conductive plastics, silver, gold or aluminum alloy. It is known by persons with common sense that there is no pure transparent material. In order to enhance transparency of the sensing unit 11, examples of applicable ways are in that first, the substrates 11A1, 11A2 and the adhesive 11B are selected with identical fraction index or the refraction indexes thereof being approximate to each other such that light deformed action (or called light twisted action) is minimized to increase transparency thereof due to the refraction indexes of different parts being minimized; and, second, the sensing technique disclosed in U.S. Pat. No. 5,880,411 is applied to admit high impedance output such that impedance coefficient of the light-penetrable conductor 11C becomes relatively higher, such as 300 OMEGA/Square, and steadier for increasing transparency of the light-penetrable conductor 11C.

An actuating layer 11D is stacked next to a side of the first substrate 11A1 or a side of the second substrate base 11A2 and the positions of the substrate 11A1, 11A2 can be observed through the actuating layer 11D. The actuating layer 11D can be a light-penetrable or light-tight substrate, an image display such as liquid crystal display (LCD), a cathode-ray tube (CRT), a fingerprint identifier, a circuit board. Alternatively, the actuating layer 11D can be neglected completely or the second substrate 11A2 is neglected and the conductor 11C is laid out onto the actuating layer 11D directly. Besides, the positions of the first substrate 11A1 and the second substrate 11A2 can be exchanged to each other without affecting the original function. In addition, in case of the first substrate 11A1 being insulated and self-adhered to the first conductor 11C directly, the adhesive 11B can be removed or neglected. The self-adhered″ means, for instance, the light-penetrable and insulated first substrate 11A1 is coated with a light-penetrable layer.

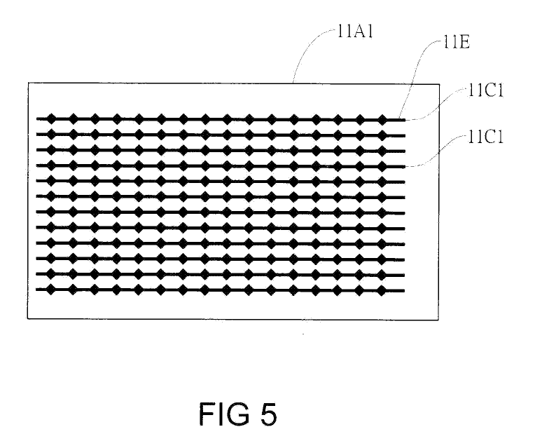

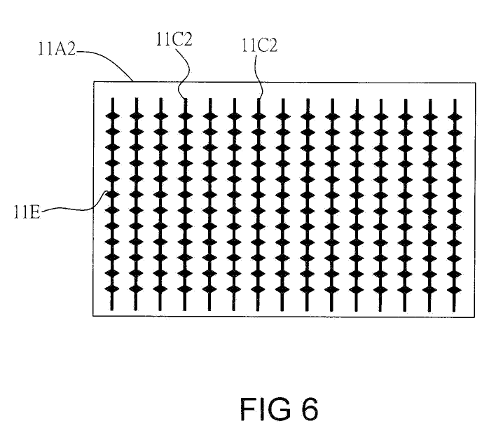

Referring to FIGS. 5 and 6, an embodiment of one-dimensional touch induced system is illustrated. The one-dimensional touch induced system is capable of detecting contact of the preceding object O and position of the preceding object O along the direction of sensing locus array arranged on the first conductor 11C. The position of the preceding object O can be figured out by means of change of capacitance value of the sensing locus array being covered and coupled with the object O. The preceding processor 12 estimates movement of the object O along the sensing locus array based on accessing continuous historical data of the position of the object O and/or integrates structure for restricting electrical noise induced by the touch pad 11.

The touch pad 11 of the one-dimensional touch induced system includes a plurality of sensing loci being laid out equidistantly along a designated axis to form a array such that sufficient rate for identifying displacement of the object 0 can be obtained. A gap between any two neighboring sensing loci can be designed to allow the object O covering at least two of the sensing loci once the object O touches any one specific position of a preset sensing zone on the touch pad 11. Hence, increased density of the sensing loci or higher accuracy of Analog/Digital (A/D) transfer, which is so called digitalization of data and can be performed with the processor 12, is capable of enhancing the touch induced system to figure out resolution of the position touched by the object O.

As the preceding illustration in FIG. 2, the first substrate 11A1 and/or the second substrate 11A2 is uniformly coated with the first light-penetrable conductor 11C and the sensing locus array formed with the first conductor 11C is laid out by means of a light resistant agent and etching process. Alternatively, a figure layer with negative light resistant layout can be coated onto the first substrate 11A1 or the second substrate 11A2. For instance, the first light-penetrable conductor 11C is deposited onto the first and second substrate 11A1, 11A2 with the splash process or coating and then the negative light resistant figure layer is removed after masking and etching to leave the sensing locus array afterward.

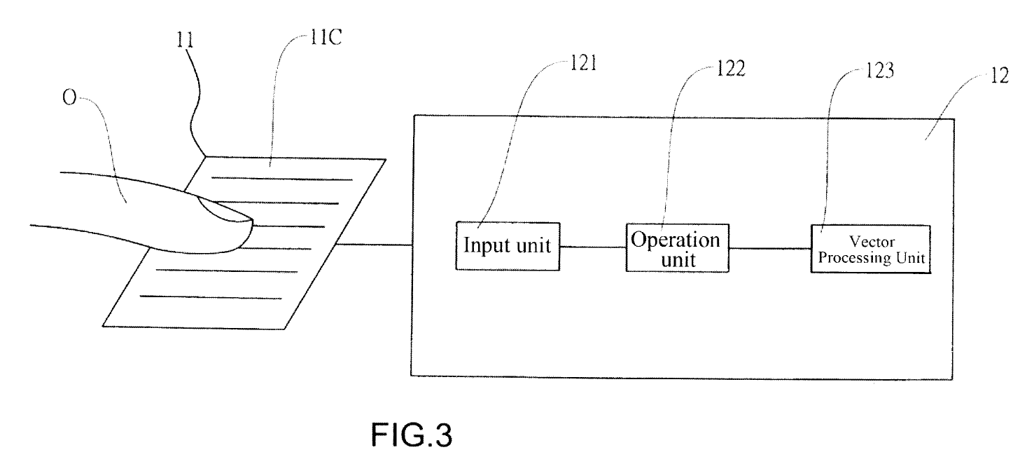

Referring to FIGS. 3 and 5, an implement mode showing part of the X-axis sensing locus arrays for figuring out position along X-axis, i.e., the sensing locus array 11C1 on the touch pad 11 is illustrated. Each sensing locus can be a light-penetrable conductor and is equidistantly spaced apart from each other with a shape of diamond 11E to form an array arranged at the light-penetrable and insulated second substrate base 11A1. The sensing loci can be increased the range thereof and the diamond zone can contain non-conductive material.

Referring to FIGS. 3 and 6, another implement mode showing part of the sensing locus arrays for figuring out position along Y-axis, i.e., the sensing locus array 11C2 on the touch pad 11 is illustrated. Each sensing locus can be a light-penetrable conductor and is equidistantly spaced apart from each other with a shape of diamond 11E to form an array arranged at the light-penetrable and insulated second substrate 11A2. The sensing loci can be increased the range thereof and the diamond zone can contain non-conductive material.

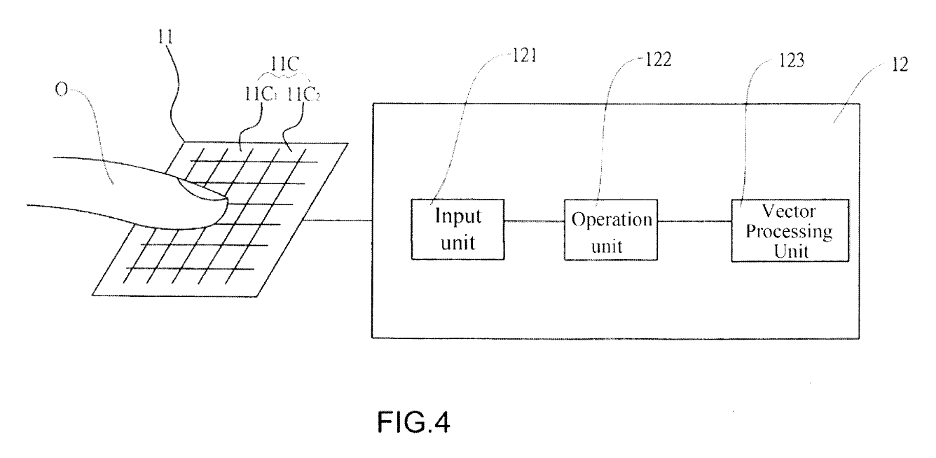

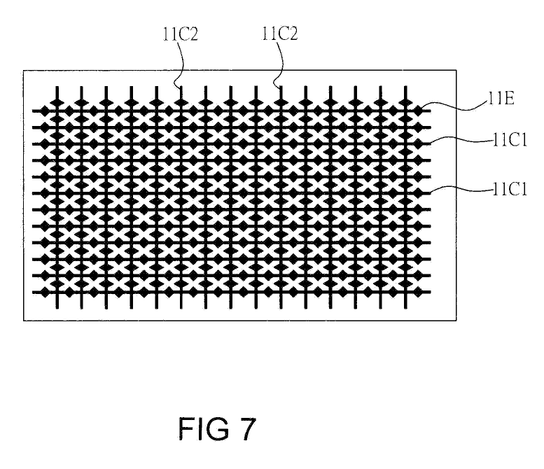

Referring to FIGS. 4 and 7, a two-dimensional touch induced system is illustrated. The two-dimensional touch induced system is capable of measuring position of the object O along two directional axes once the object O appears on the touch pad 11. For explanation purpose, the two axes are designated as X-axis and Y-axis.

Actual number of the preceding sensing locus array and presence of the two axes are determined with requirement to the sensing zone and the identification rate of a specific system. In order to meet sufficient identification rate of position, each of the sensing loci is designed to space apart from each other with a gap in a way of at least two sensing loci being covered by the object O once the object O is disposed at a preset position along respective axis of the sensing zone.

The preceding FIG. 6 is bottom view showing the second substrate 11A2 at the top with Y-axis sensing locus array and the first substrate 11A1 at the bottom with X-axis sensing locus array. It is appropriate that at least a first light-penetrable conductor 11C layer is filled the entire sensing zone. The first light-penetrable conductor 11C is made of such as ITO, gold or silver.

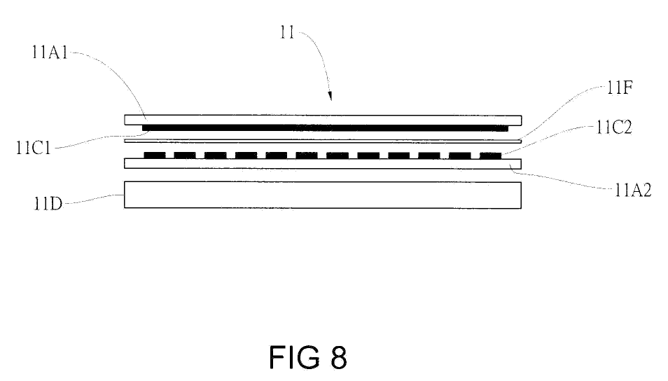

Referring to FIG. 8, a preferred embodiment of structure of a touch pad 11 for two-dimensional touch induced system is illustrated. The first light-penetrable and insulated substrate 11A1 is the top side for being touched with the object O. The light-penetrable X-axis sensing loci 11C1 are disposed next to a side of the first substrate 11A1. A thin, light-penetrable and good adhered insulator 11F is disposed next to the X-axis sensing loci 11C1 to partition the X-axis sensing loci 11C1 from a Y-axis sensing loci 11C2. Similarly, the Y-axis sensing loci 11C2 are attached to a side of the second light-penetrable and insulated substrate 11A2.

It is noted that technique related to the light-penetrable substrate 11A1, 11A2, adhesive 11B, insulator 11F, the X-axis sensing loci 11C1 and the Y-axis sensing loci 11C2 illustrated in FIG. 2 is suitable for applying to the two-dimensional touch pad 11 as well.

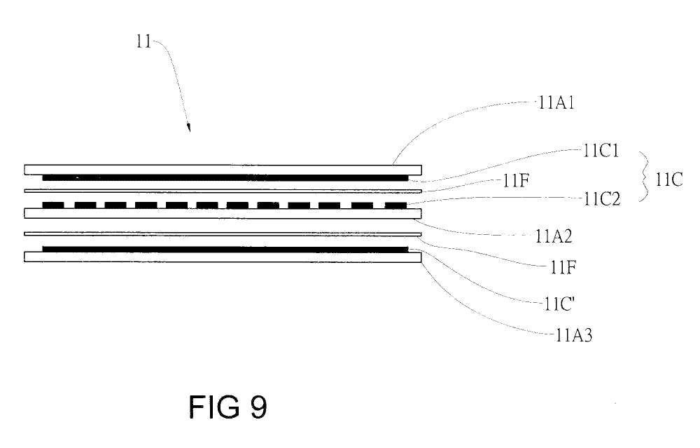

Further, an electronic protect shield (not shown) can be employed in the preceding embodiment to isolate noise of the sensing loci and that induced by electronic circuit of the touch induced system. Besides, Referring to FIG. 9, another embodiment of a touch pad for two-dimensional touch induced system is illustrated. The arrangement between the first substrate 11A1 and the second substrate 11A2 shown in FIG. 9 is the same as the embodiment illustrated in FIG. 8. The difference the embodiment illustrated in FIG. 9 from FIG. 8 is in that another light-penetrable insulator 11F is disposed next to another side of the second substrate 11A2 and a second light-penetrable conductor 11C′, which is attached to a third substrate base 11A3, is disposed next to the light-penetrable insulator 11F. The second light-penetrable conductor 11C′ is a grounded conductor layer and different from the first conductor 11C with X-axis sensing loci 11C1 and Y-axis sensing loci 11C2. The second conductor 11C′ is capable of providing electronic protection for touch pad 11 to avoid interference of noise. The second conductor 11C′ and the third substrate 11A3 can be light-penetrable or light tight material as illustration of FIG. 2. No further detail relating the material of the conductor 11C′ and the third substrate 11A3 will be discussed.

The second conductor 11C′ and/or the third substrate 11A3 can be disposed between the second substrate 11A2 and the actuating layer 11D. That is, the second conductor 11C′ and the substrate 11A3 being employed as a transparent ground plate is adaptable for the stacked one-dimensional touch pad 11 shown in FIG. 2

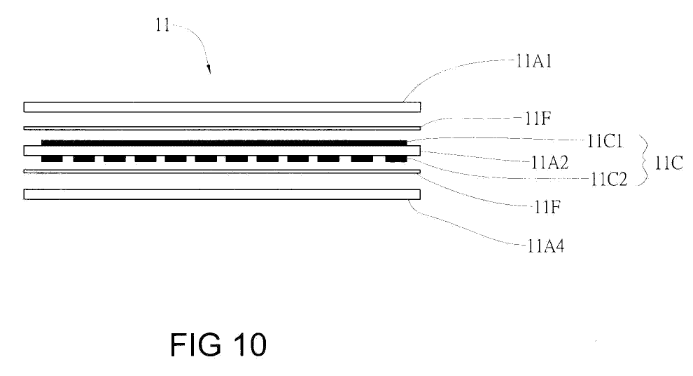

Referring to FIG. 10, a further embodiment of a touch pad for two-dimensional touch induced system is illustrated. A first light-penetrable substrate 11A1 is adhered a first light-penetrable conductor 11C via a light-penetrable insulator 11F as shown in FIG. 2. The first conductor 11C includes an array of X-axis sensing loci 11C1, which is coated onto a side of a second substrate base 11A2, and an array of Y-axis sensing loci 11C2, which is coated onto another side of the second substrate base 11A2. A third substrate base 11A4 is adhered to the array of Y-axis sensing loci 11C2 of the first conductor 11C via another light-penetrable insulator 11F. Because the sensing loci 11C1 and the sensing loci 11C2 can be arranged to cover both sides of the second substrate base 11A2 and the sensing loci 11C1 can be aligned to the sensing loci 11C2 before the light resistant agent laid out locus array being etched/deposited, it simplifies error adjustment of the laid-out X-axis and Y-axis sensing loci tremendously.

The preceding light-penetrable and insulated substrates 11A1, 11A2, 11A4 are suitable for one-dimensional touch pad 11 too. Further, for electronic protection, the light-penetrable substrate 11A4 can be used in the embodiment shown in FIG. 9 instead of the second conductor 11C′ and the first substrate base 11A1.

Increasing density of the preceding sensing loci is capable of allowing a fine tip conductive stylus to couple at least two sensing loci. Alternatively, increasing accuracy of A/D transfer is capable of promoting sensitivity of detection instantaneous capacitance change of the sensing loci, which are X-axis conductor sensing loci 11C1 and Y-axis conductor sensing loci 11C2.

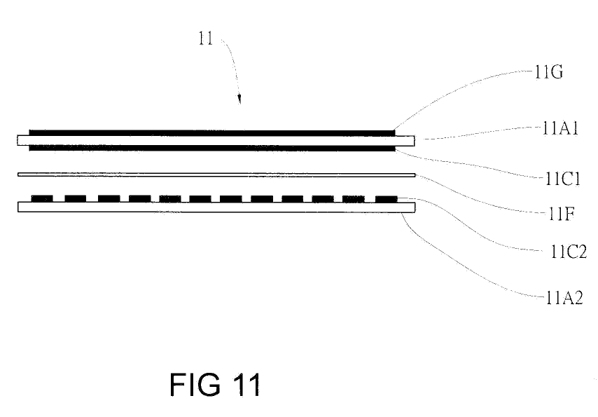

Referring to FIG. 11, a further embodiment of structure of a touch pad for a two-dimensional sensing induced system is illustrated. The stacked layer shown in FIG. 11 is almost the same as the preceding embodiments shown in FIGS. 8 and 9. The difference of the embodiment shown in FIG. 11 is in that a side of the first substrate 11A1 is covered with a light-penetrable impedance coating layer 11G offering the stylus an extended effective contact area.

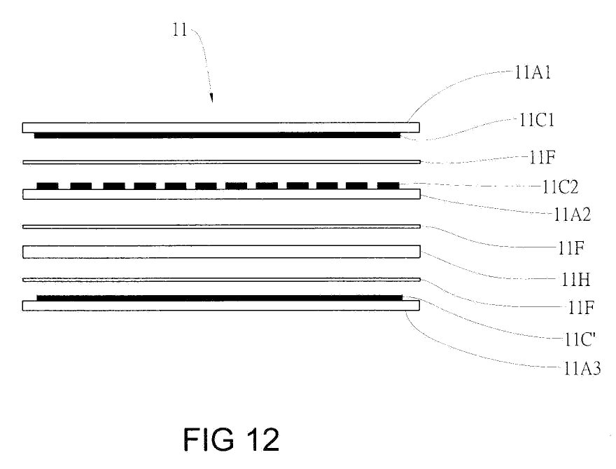

Referring to FIG. 12, a further embodiment of structure of a touch pad for a two-dimensional sensing induced system is illustrated. The first substrate 11A1 and the second substrate 11A2 are same as the preceding two-dimensional touch pad 11. The difference of the embodiment shown in FIG. 12 is in that the first substrate 11A1 and the second substrate 11A2 are made of elastic and flexible material such as polyester film. Further, the second substrate base 11A2 is adhered a light-penetrable and flexible electric medium layer 11H with a light-penetrable insulator 11F at a side opposite the side attached to the Y-axis sensing loci. In addition, the flexible electric medium layer 11H further adheres a third substrate base 11A3, which is attached with a second conductor 11C′ (X-axis sensing loci 11C1 or Y-axis sensing loci 11C2), with a further insulator 11F. The third substrate base 11A3 is made of rigid material such as glass or polycarbonate plastics or circuit board made of the rigid material. The second conductor 11C′ can be electronically grounded light-penetrable homogeneous conductor layer.

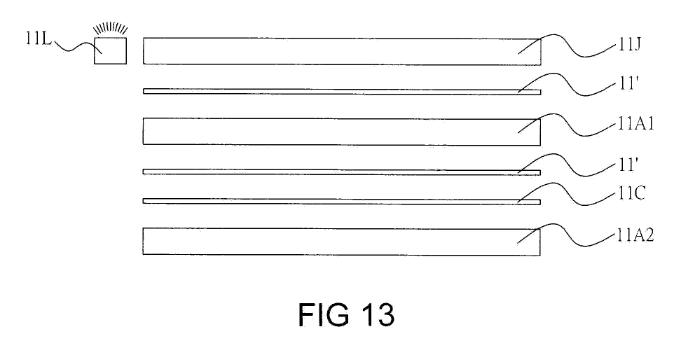

Referring to FIG. 13, the first substrate base 11A1 can be used as light reflection layer and a guide light layer 11J can be adhered to a side of the first substrate 11A1 with a joining layer 11′ such as the preceding adhesive 11B or insulator 11F. The second substrate 11A2 can be used as a circuit board or provides the first conductor 11C (X-axis sensing loci 11C1 and/or Y-axis sensing loci 11C2). Besides, at least an illuminant component 11L can be disposed next to the periphery of the guide light layer 11J, for instance, at a lateral side of the first substrate 11A1 and/or the second substrate 11A2 or under the first substrate 11A1 and/or the second substrate 11A2 to connect with electric circuit of the second substrate 11A2 or the preceding processor 12 (not shown). Thus, once the user presses the guide light layer 11J to urge the first substrate 11A1 and/or the joining layer to contact the first conductor 11C such that capacitance is capable of being changed. The electrical circuit on the second substrate 11A2 or the processor 12 can receive change of capacitance value to control “On” and “Off” of the illuminant component 11L. Further, light of the illuminant component 11L is reflected with the first substrate 11A1 and/or refracted with the guide light layer to prompt location and range of the touch pad 11 for the user. Moreover, the electrical circuit of the second substrate 11A2 can be arranged either to integrate with or separate from the processor 12.

While the invention has been described with referencing to preferred embodiments thereof, it is to be understood that modifications or variations may be easily made without departing from the spirit of this invention, which is defined by the appended claims.

What is claimed is:

1. A touch pad structure comprising:
a first substrate with a first side and a second side being opposite to each other;
a joining layer being adhered to the first side;
a guide light layer being disposed next to the joining layer;
a second substrate being disposed next to the second side and providing electrical circuit and a conductor; and
at least an illuminant component being provided beside periphery of the guide light layer to connect with the electrical circuit.

2. The touch pad structure as defined in claim 1, wherein the first substrate is made of polycarbonate plastics.

3. The touch pad structure as defined in claim 1, wherein the first substrate is made of Mylar.

4. The touch pad structure as defined in claim 1, wherein the first substrate is made of polyester film.

5. The touch pad structure as defined in claim 1, wherein the first substrate is made of glass.

6. The touch pad structure as defined in claim 1, wherein the conductor is deposited onto a side of the second substrate with splash process.

7. The touch pad structure as defined in claim 1, wherein the conductor is deposited onto a side of the second substrate by means of printing.

8. The touch pad structure as defined in claim 1, wherein the conductor is formed with a plurality of light-penetrable sensing loci and layout of the sensing loci is obtained by means of light resistant agent and etching process.

9. The touch pad structure as defined in claim 1, wherein the conductor is formed with a plurality of light-penetrable sensing loci and layout of the sensing loci is obtained by means of a negative figure layer covering the second substrate and removing the negative figure layer.

10. The touch pad structure as defined in claim 1, wherein at least a side of the conductor is formed with a plurality of light-penetrable sensing loci.

11. The touch pad structure as defined in claim 1, wherein the conductor comprises X-axis sensing loci and Y-axis sensing loci.

12. The touch pad structure as defined in claim 1, wherein the electrical circuit is integrated with a processor.

13. The touch pad structure as defined in claim 1, wherein the electrical circuit is connected to a processor.

14. The touch pad structure as defined in claim 1, wherein the illuminant component is disposed at a periphery side of the first substrate and/or the second substrate or under the first substrate and/or the second substrate.
